(19) United States
(12) Patent Application Publication
(10) Pub. No.: US 2016/0027061 A1
(43) Pub. Date: Jan. 28, 2016

(54) Repositioning Previously Presented Content Items For Presentation To A User Via An Updated News Feed

(71) Applicant: Facebook, Inc, Menlo Park, CA (US)

(72) Inventors: Tanmoy Chakraborty, San Mateo, CA (US); Anand Sumatilal Bhalgat, Mountain View, CA (US); Chinmay Deepak Karande, Mountain View, CA (US)

(21) Appl. No.: 14/341,680

(22) Filed: Jul. 25, 2014

(51) Int. Cl. G06Q 30/02; G06Q 50/00

(52) U.S. Cl. CPC G06Q 30/0269; G06Q 30/0275; G06Q 50/01

(57) ABSTRACT

A social networking system presents content items, such as news feed stories and advertisements, to a user of the social networking system via a news feed. The social networking system determines to again present a content item via the news feed or to present a previously presented content item in a different position of the news feed. The social networking system identifies additional content items to present to the user as well as content items previously presented to the user. The social networking system scores the additional content items and the previously presented content items, accounting for a cost of removing the previously presented content item from its original position for presentation in the alternative position. Based on the score the social networking system ranks the content items selects, based on the rank, content items to present to the user.

### BACKGROUND

This disclosure relates generally to social networking systems, and in particular to presenting advertisements and other content to users of a social networking system.

Users of a social networking systems share their interests and engage with other users of the social networking system by sharing photos, real-time status updates, and playing social games. The amount of information gathered from users is staggering—information describing a variety of “newsworthy” items, including recent moves to a new city, graduations, births, engagements, marriages, and the like, as well as more mundane content such as status messages, information about what music has been listened to by users, and recent check-in events at coffee shops. As users become more connected with other users and entities on the social networking system, the number of content items provided to the users increases exponentially.

Further, apart from user-generated content items a number of advertisements (ads) are also served to users of the social networking system. Existing social networking systems have ordered content items in reverse chronological order such that newly published content and ads are displayed first. However, as a result of a flood of content items published on social networking systems, users often not have an opportunity to view or interact with ads and content items previously presented to the user, that are particularly relevant to the user. This leads to a decline in the user experience, as well as users becoming less engaged with the social networking system as they tend to miss content previously presented by the user.

### SUMMARY

A social networking system presents content items to a user of the social networking system via a news feed and maintains a view state identifying the content items and an order in which the identified content items are presented to the user. For example, the news feed includes multiple positions, with each content item presented in a position, so a view state identifies a content item presented to the user and a position in the news feed in which the content item was presented. The content items presented via the news feed include news feed stories describing actions of other social networking system users and sponsored content, such as advertisements. The social networking system may receive a request from a user to refresh or update the news feed, upon which the social networking system identifies additional content items to present to the user as part of the refreshed news feed, or identifies previously presented content items included in the news feed but not viewed by the user to present again to the user.

The social networking system determines whether to again present an advertisement that was previously presented to the user, such as an advertisement that was not previously viewed by the user, via the news feed. In one example, the social networking system determines whether to reposition an advertisement that was previously presented to the user via the news feed based on a bid amount associated with the advertisement or associated with repositioning an advertisement. In another example, the social networking system receives a request, including a bid amount and an identifier identifying the advertisement, to reposition the advertisement from the advertiser. In some embodiments, the request may also include a position in the news feed for presenting the identified advertisement or a minimum position in the news feed for presenting the identified advertisement. The social networking system generates scores for additional content items that have not previously been presented via the news feed and for content items previously presented to the user (“previously presented content items”) via the news feed.

A previously presented content item is scored based on a value to the social networking system for presenting the content item in a different position than its original position less a value to the social networking system for removing the previously presented content item from its original position in the news feed. Additionally, when scoring a previously presented content item, the social networking may further decrease the value to the social networking system for presenting the content item in the different position by a decrease in value to the social networking system based on displacement of the content items in the news feed between the original position of the previously presented content item and the different position for subsequently presenting the previously presented content item. However, an additional content item is scored based on the value to the social networking system for presenting the additional content item less a decrease in value to the social networking system from displacing content items in the news feed presented in positions in the news feed lower than a position in which the additional content item is to be placed. Based on the scores associated with the additional content items and the previously presented content items, the social networking system ranks the additional content items. Based at least in part on the ranking, the social networking system selects content items to present to the user via the news feed. If a previously presented content item is selected for presentation via the news feed, the previously presented content item is removed from its original position in the news feed and presented in a different position in the news feed based on the ranking.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIGS. 3A-3C show an example of arranging content in a news feed to be presented to a user of the social networking system, in accordance with an embodiment.

FIG. 4 shows a method for selecting content items for presentation to a social networking system user via a news feed, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

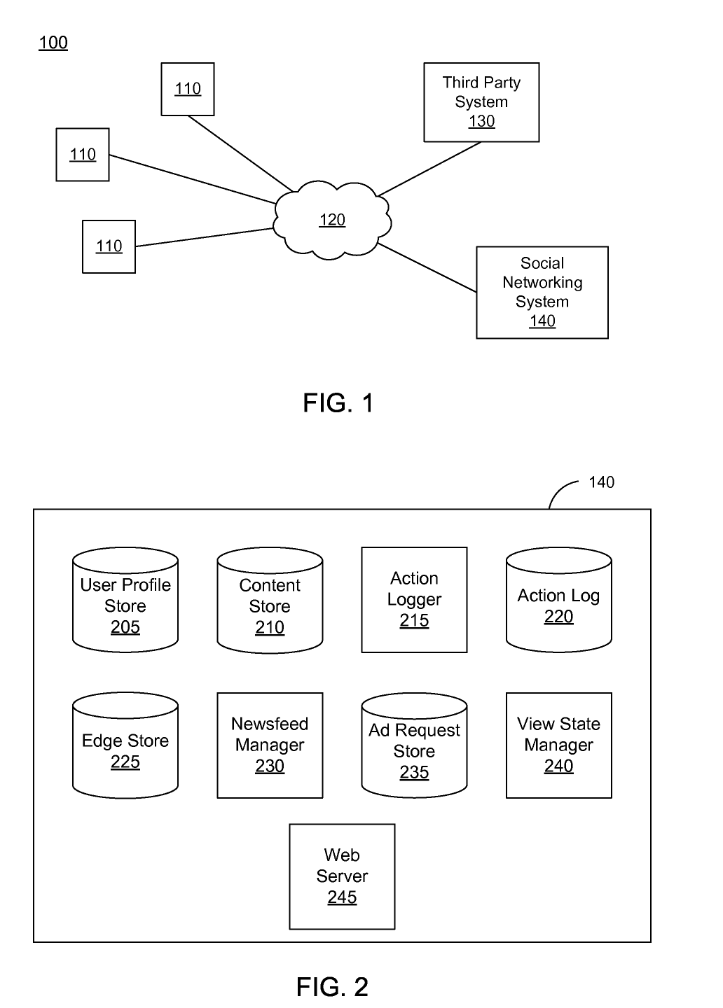

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

FIG. 2 is an example block diagram of an architecture of the social networking system 140. The social networking system 140 shown in FIG. 2 includes a user profile store 205, a content store 210, an action logger 215, an action log 220, an edge store 225, news feed manager 230, ad request store 235, view state manager 240, and a web server 245. In other embodiments, the social networking system 140 may include additional, fewer, or different components than those described in conjunction with FIG. 2. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 210. Examples of interactions with objects include: commenting on posts, sharing links, and checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website that primarily sells sporting equipment at bargain prices may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest an object or in another user in the social networking system 140 based on the actions performed by the user. A user's affinity may be computed by the social networking system 140 over time to approximate a user's interest for an object, a topic, or another user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

In one embodiment, the social networking system 140 identifies stories and other content items, such as advertisements, likely to be of interest to a user through a “news feed” presented to the user. A news feed story presented to a user describes an action taken by an additional user connected to the user and identifies the additional user. A news feed story may describe objects represented in the social networking system, for example, an image, a video, a comment from a user, status messages, external links, content generated by the social networking system, applications, games, a user profile or other types of content items present in the content store. In some embodiments, a news feed story describing an action performed by a user may be accessible to users not connected to the user that performed the action. The news feed manager 230 may generate stories for presentation to a user based on information in the action log 220 and in the edge store 225 or may select candidate news feed stories included in content store 210. One or more of the candidate news feed stories are selected and presented to a user by the news feed manager 230.

The news feed manager 230 generates the news feed stories for presentation in a news feed, selects content items for presentation via the news feed, and communicates the news feed to one or more client devices 110 for presentation to users. An example operation of the news feed manager 230 is further described in U.S. patent application Ser. No. 14/031,453, filed on Sep. 19, 2013, which is hereby incorporated by reference in its entirety. In one embodiment, the news feed manager 230 receives a request to present one or more news feed stories to a social networking system user from a client device 110 and accesses one or more of the user profile store 205, the content store 210, the action log 220, and the edge store 225 to retrieve information about the user. For example, news feed stories or other data associated with additional users connected to the user are retrieved. The retrieved news feed stories or other data are analyzed by the news feed manager 230 to identify content likely to be relevant to the user. For example, news feed stories associated with additional users not connected to the user or news feed stories associated with additional users for which the user has less than a threshold affinity are discarded as candidate news feed stories. Based on various criteria, the news feed manager 230 selects one or more of the candidate news feed stories for presentation to the identified user.

In various embodiments, the news feed manager 230 presents news feed stories to a user through a news feed including a plurality of news feed stories selected for presentation to the user. In some embodiments, the news feed includes a plurality of positions that are each configured to present a content item, such as a news feed story or an advertisement. The news feed may include a limited number of news feed stories or may include a complete set of candidate news feed stories. For example, the number of news feed stories included in a news feed may be determined in part by a user preference included in user profile store 205. The news feed manager 230 may also determine the order in which selected news feed stories are presented via the news feed. For example, the news feed manager 230 determines that a user has a highest affinity for a specific user and increases the number of news feed stories in the news feed associated with the specific user or modifies the positions in the news feed where news feed stories associated with the specific user are presented. In one embodiment, content items presented via the news feed are presented in reverse chronological order based on timestamps associated with the content items.

The news feed manager 230 may also account for actions by a user indicating a preference for types of news feed stories and selects news feed stories having the same, or similar, types for inclusion in the news feed. Additionally, the news feed manager 230 may analyze news feed stories received by social networking system 140 from various users to obtain information about user preferences or actions. This information may be used to refine subsequent selection of news feed stories for news feeds presented to various users.

In some embodiments, the news feed manager 230 associates a position discount with each position in a news feed. The position discount value reflects a predicted decrease in user interaction with a news feed story based on the position of the news feed story in the news feed. When a news feed is presented to a user, the likelihood of a user interacting with a content item presented via the news feed varies depending on the position in the news feed in which the content item is presented. For example, a user has a likelihoods of interacting with content items presented in positions proximate to an upper boundary (or “top”) of the news feed than of interacting with content items presented in positions of the news feed distant from the top of the news feed. The position discount value associated with a position may be based at least in part on a distance between the position and a reference position in the news feed. For example, the reference position is a topmost, or “highest” position in the news feed. Other methods of determining a position discount value associated with a position in a news feed are described in U.S. patent application Ser. No. 14/049,429, filed on Oct. 9, 2013, which is hereby incorporated by reference in its entirety.

In addition to selecting news feed stories for presentation via a news feed, the news feed manager 230 may select one or more advertisements for presentation via the news feed. For example, a news feed presented to a user may include one or more advertisements as well as news feed stories. To select news feed stories or advertisements for presentation via a news feed, the news feed manager determines scores for the advertisements and for the news feed stories. A score for an advertisement is based at least in part on a bid amount associated with the advertisement, an expected amount of interaction with the advertisement, as well as a position discount associated with a position in the news feed in which the advertisement is to be presented. A score for a news feed story is based at least in part on an expected amount of interaction with the news feed story and a position discount associated with a position in the news feed in which the news feed story is to be presented, and the position discount associated with a position in the news feed. Based on the scores associated with news feed stories and advertisement, the news feed manager 230 ranks the news feed stories and advertisements and selects content for presentation via the news feed based on the ranking.

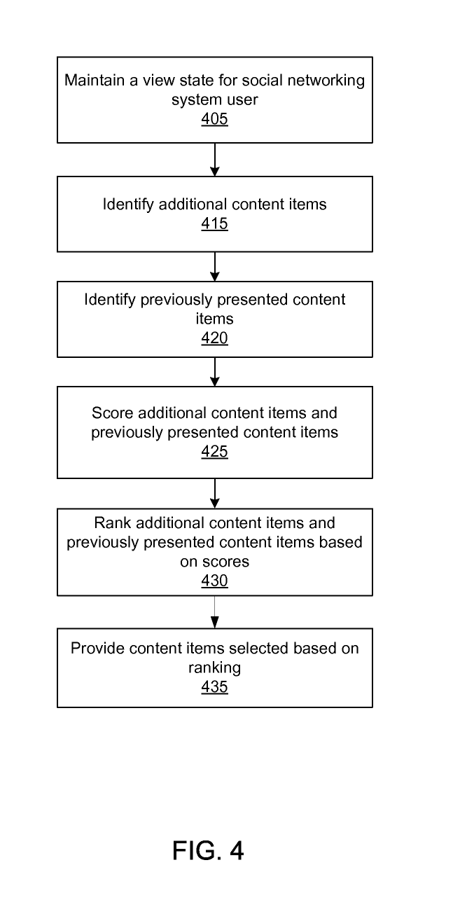

The news feed manager 230 may receive a request for an updated or refreshed news feed, or for additional content to be included in the news feed from a user viewing the news feed on a client device 110 (a “viewing user”). The news feed manager 230 responds to the request from the client device 110 by determining content items (e.g., news feed stories and advertisements) previously presented to the viewing user. Additional content items that have not previously been presented to the viewing user are also identified and scored, as further described below in conjunction with FIG. 4. The additional content items and previously presented content items are ranked based on their associated scores, and content is selected for inclusion in the news feed based on the ranking. For example, the news feed manager 230 selects additional content items or previously presented content items having at least a threshold position in the ranking for inclusion in the news feed. The news feed manager 230 may use information about the viewing user to determine the ranking of the additional content items and previously presented content items.

The news feed manager 230 may provide previously presented news feed stories below the additional news feed stories for presentation to the viewing user based on information received from the client device 110 associated with the viewing user indicating the viewing user has finished consuming the previously presented news feed stories. As a result, the viewing user will see the highest-ranked additional news feed stories, followed by the remaining additional news feed stories, and then previously presented news feed stories. Such an input may be communicated from the client device 110 to the social networking system 140 in response to the client device 110 receiving a user input. Examples of user inputs include clicking on, or otherwise selecting, a link in a news feed user interface for more content items, detecting a scroll action from the user, receiving clicking actions on various content items in a news feed user interface, and at least a threshold time spent viewing a news feed after presenting the news feed to the viewing user via the client device 110.

The news feed manager 230 records, for each user on the social networking system 140, a “view state” of the content item that have been presented in each user's news feed, storing the order of the news feed stories that have been presented. In one example, a view state associated with a user associates an identifier of a content item presented to the user with a position in a news feed in which the content item was presented. The view state at a particular time may be stored in a view state object associated with the user in the user profile store 205 or in the content store 210. Using this view state, the news feed manager 230 may determine whether content items have evolved, changing the ranking of the content items.

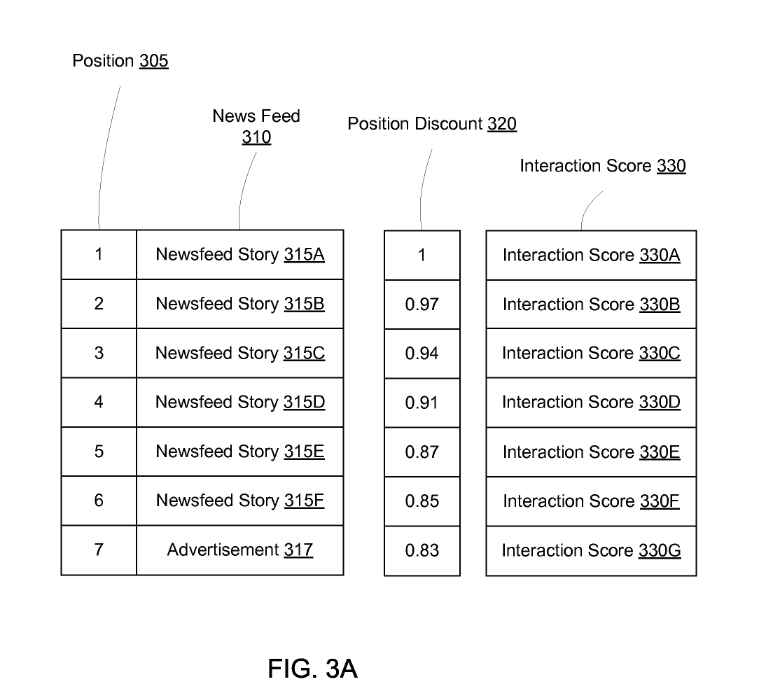

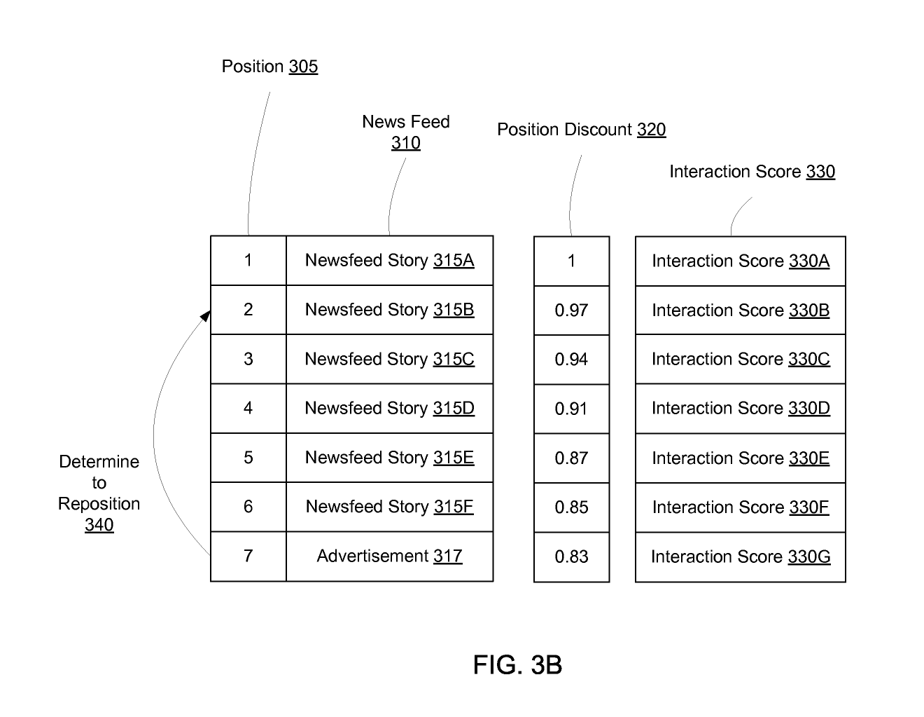

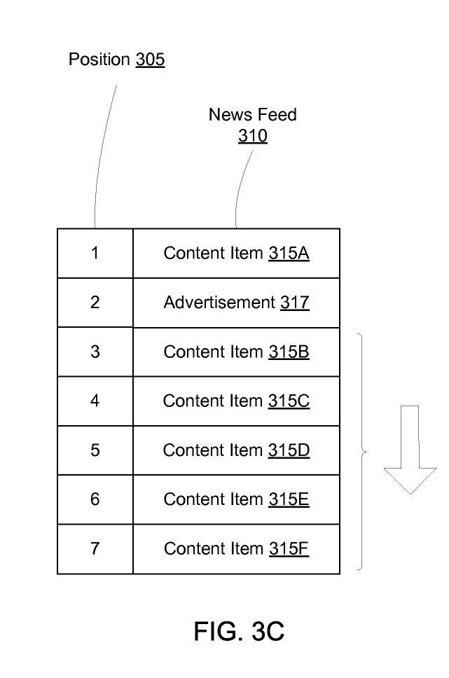

In one embodiment, the news feed manager 230 repositions previously presented news feed stories or advertisements, by moving the news feed stories or advertisements to a higher position in the news feed while removing the news feed stories or advertisements from the positions in which they were originally presented, as further described below in conjunction with FIGS. 3 and 4. For example, if the news feed manager 230 determines a user has not viewed an advertisement, the news feed manager 230 repositions the advertisement into an alternative position in the news feed that is higher than the position in the news feed in which the advertisement is currently presented. The news feed manager 230 determines whether to reposition the advertisement from its original position in the news feed to an alternative position in the news feed based on a bid amount associated with the advertisement, the position discount of the position in which the advertisement was originally presented, the position discount of the alternative position, and a cost of displacing content items presented in the news feed in positions between the alternative position and the position in which the advertisement was originally presented, as further described below in conjunction with FIGS. 3 and 4.

One or more advertisement requests (“ad requests”) are included in the ad request store 235. An advertisement request includes advertisement content (also referred to as an “advertisement”) and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed by a user.

Additionally, an advertisement request may include one or more targeting criteria specified by the advertiser. Targeting criteria included in an advertisement request specify one or more characteristics of users eligible to be presented with advertisement content in the ad request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The view state manager 240 determines when to capture a view state of the news feed for each user of a social networking system 140. A viewing user may login to a social networking system 140 to initiate a viewing session of a news feed. Throughout the viewing session, content items (e.g., news feed stories or advertisements) may be provided to the viewing user via the news feed, which changes a view state associated with the viewing user. The view state manager 240 may determine that, after each content item is presented to a user via a news feed, a view state associated with the user is updated and stored in the content store 210 or in the user profile store 205. In one embodiment, the view state is updated when a user's session interacting with the social networking system 140 expires. The session may expire based on a lack of engagement with or activity on the social networking system 140 by the user. For example, a user may open a web browser on a client device 110 to connect to the social networking system 140. After browsing news feed stories, the user may open another browser window to view other web pages not connected to the social networking system 140. In one embodiment, the session created when the user first connected with the social networking system 140 expires based on a predetermined time period of non-activity elapsing. In another embodiment, the viewing session expires when the user logs out of the social networking system 140. When a session expires, the view state, which includes an order in which content items were presented via a news feed and indications of whether news feed stories were featured or highlighted as a top news feed story, is stored in the content store 210, and is associated with the user's user profile stored in the user profile store 205.

Using the view state manager 240, the news feed manager 230 may determine that the user is not yet ready to read or consume additional content items. For example, if a user starts a new session but does not scroll down the news feed, the news feed manager 230 infers that the user has not yet read news feed stories or other content items provided on the news feed user interface. If that user later starts another session, the previously presented news feed stories remain frozen on the news feed user interface using the view state previously stored by the view state manager 240.

The web server 245 links the social networking system 140 via the network 120 to the one or more client devices 110, as well as to the one or more third party systems 130. The web server 140 serves web pages, as well as other web-related content, such as JAVA®, FLASH®, XML and so forth. The web server 245 may receive and route messages between the social networking system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

### Example Repositioning an Advertisement in a News Feed

The social networking system 140 presents news feed stories and advertisements to a user via a news feed. As a user navigates through a news feed, the user may not view one or more news feed stories or advertisements presented to the user via the news feed. To increase user interaction with presented news feed stories or advertisements, the social networking system 140 may reposition previously presented news feed stories or advertisements, such as those not viewed by the user, in the news feed to increase the likelihood of the user viewing the previously presented news feed story or advertisement as described below with respect to FIGS. 3A-3C and FIG. 4. Further, as described in conjunction with FIGS. 3A-3C and FIG. 4, the social networking system 140 again presents or repositions a previously presented news feed story or advertisement, by removing the previously presented news feed story or advertisement from its original position in the news feed and placing the previously presented news feed story or advertisement in an alternative position in the news feed or an updated version of the news feed.

FIGS. 3A-3C show an example of arranging content in a news feed to be served to a user of the social networking system, in accordance with one embodiment. As used herein, “content items” refer to news feed stories, advertisements, or any combination thereof. In the example of FIG. 3A, a news feed 310 presented to a social networking system user includes news feed stories and advertisements; however, in other embodiments, other types of content items may be presented via the news feed 310. The news feed 310 in FIG. 3A includes multiple news feed stories 315A, 315B, 315C, 315D, 315E, 315F (individually and collectively referred to using reference number 315) and an advertisement (“ad”) 317. Each news feed story 315 or ad 317 is presented in a position 305 of the news feed 310 representing a location in the news feed 310 in which the content item 315 or ad 317 is presented relative locations in the news feed 310 in which to the other content items 315 or ads 317 are presented. In the example of FIG. 3A, news feed story 315A is presented in position 1, news feed story 315B is presented in position 2, and news feed stories 315C, 315D, 315E, 315F are, respectively, presented in positions 3, 4, 5, and 6. Ad 317 is presented in position 7 of the news feed 310 in the example of FIG. 3A. In this example, a user viewing the news feed 310 on a client device 110 may scroll or navigate through the news feed 310 to view content items presented in positions lower than position 7.

Each position 305 in the news feed 310 is associated with a position discount 320 that reflects a predicted decrease in user interaction with a content item based on a position 305 in which the content item is presented in the news feed 310. As described above in conjunction with FIG. 2, likelihoods of a user interacting with a content item presented via the news feed 310 vary depending on the position 305 in the news feed 310 in which the content item is presented. As an example, in FIG. 3A, a user has a higher likelihood of interacting with a content item presented in position 1 than with a content item presented in position 5. For example, when the news feed 310 is presented to a user via a client device 110, positions 1, 2, 3, and 4 are visible to the user, so news feed stories 315A, 315B, 315C, and 315D are more likely to receive interaction from the user than content items presented in positions 5, 6, and 7. Hence, larger position discounts 320 are associated with positions 5, 6, and 7, than with positions 1, 2, 3, and 4. In some embodiments, the position discount 320 associated with a position 305 is based on a distance between the position 305 and a reference position. In FIG. 3A, the reference position is position 1, so the position discounts 320 associated with positions 2-7 are based on a number of positions between positions 2-7 and position 1. In the example of FIG. 3A, position 1 is associated with a position discount of 1, which corresponds to no discount, while position 2 is associated with a position discount of 0.97, position 3 is associated with a position discount of 0.94, and positions 4, 5, 6, and, 7 are associated with positions discounts of 0.91, 0.87, 0.85, and 0.83, respectively.

Each content item presented via in the news feed 310 is also associated with an interaction score 330 representing an expected amount of interaction by a user presented with the news feed 310 with a content item. Examples of user interactions with a content item include expressing a preference for a content item, commenting on a content item, or sharing a content item with another user. The interaction score 330 associated with the content item indicates a likelihood of the user performing one or more types of interactions with the content item. In one example, the interaction score 330 is calculated as a dot product between a vector including values associated with different types of user interactions with a content item 315 and a vector including probabilities of a user performing different types of interactions with the content items 315. Thus, the interaction score 330 associated with a content item presented in the news feed 310 is based on the likelihoods of the user performing various types of interactions with the content item. In the example, of FIG. 3A, news feed stories 315A, 315B, 315C, 315D, 315E, 315F are associated with interaction scores 330A, 330B, 330C, 330D, 330E, 330F, respectively, and advertisement 317 is associated with interaction score 330G respectively.

In FIG. 3B, the social networking system 140 determines 340 to reposition the advertisement 317 into an alternative position of the news feed 310. For example, the social networking system 140 determines 340 to reposition the advertisement 317 to a higher position in the news feed based on a bid amount associated with the advertisement 317. The social networking system 140 may determine to reposition the advertisement 317 based on a lack of user interaction with the advertisement 317, based on a desire by an advertiser to increase visibility of the advertisement 317, or based on any other suitable criteria. In the example of FIG. 3B, the social networking system 140 determines 340 to reposition the ad 317 from position 7 to position 2 in the news feed 310. In some embodiments, the social networking system determines 340 to reposition the advertisement 317 based request to reposition the advertisement 317 received from an advertiser.

In one embodiment, the social networking system 140 receives a request from an advertiser including an identifier associated with the advertisement 317 and a bid amount specifying an amount of compensation from the advertiser to the social networking system 140 for again presenting the advertisement to the user or for repositioning the advertisement 317 in a different position of the news feed. The request may also include other parameters for repositioning or subsequently presenting the advertisement 317. Example parameters include an indication whether the advertisement 317 may be presented in a position other than the position indicated in the request 340 (e.g., a next best position for subsequently presenting the advertisement 317), whether to automatically reposition the advertisement if one or more criteria are specified (e.g., if the advertisement 317 is presented in a position 305 lower than a threshold position). Based on the bid amount associated with presenting the advertisement 317 or based on the bid amount included in the request to reposition, the position discounts 320 and interaction scores 330 associated with various positions 305 in the news feed 310, the social networking system 140 determines whether to again present or to reposition the advertisement 317 in the news feed 310, as further described below in conjunction with FIG. 4 below. In one example, the social networking system 140 determines whether to again present or reposition the advertisement 317, based on a value to the social networking system 140 from presenting the advertisement 317 in the position identified by the request 340 determined from the bid amount in the request 340 and an amount of compensation lost by the social networking system from removing the advertisement 317 from presentation in its original position, determined from a bid amount previously received for presenting the advertisement 317, as further described below in conjunction with FIG. 4 below.

FIG. 3C illustrates the news feed 310 if the social networking system 140 determines to reposition the advertisement 317. As shown in FIG. 3C, the social networking system 140 repositions the advertisement 317 for presentation in position 2 of the news feed 310 if the social networking system 140 determines to reposition the advertisement 317. Repositioning the advertisement 317 into position 2 causes the news feed stories 315B, 315C, 315D, 315E, 315F previously presented in positions 2, 3, 4, 5 and 6, to be repositioned for presentation in positions 3, 4, 5, 6 and 7, to accommodate the repositioning of the advertisement 317. Additionally, as shown in FIG. 3C, the advertisement 317 is removed from presentation in position 7 when it is repositioned, or again presented, in position 2 to increase the likelihood of the user interacting with the advertisement 317.

### Selecting Content Items and Advertisements to Include in a News Feed

FIG. 4 shows one embodiment of a method for selecting content items to provide to a social networking system user. As used herein, “content items” refer to news feed stories, advertisements, or any combination thereof. The social networking system 140 maintains 405 a view state for a social networking system user. The view state identifies content items and an order in which the identified content items are presented to the user. For example, the view state associates content item identifiers with positions in a news feed in which the content items were presented. As described above, the content items include news feed stories and advertisements, as the news feed may present both news feed stories and advertisements. In one embodiment, the view state for a user is stored in the content store and is associated with the user's user profile stored in the user profile store 205 and modified each time content items are provided to the user via the news feed. The view state may be maintained 405 over time to store the order in which content items have been presented to the user via the news feed. Associating a view state with a user profile maintained by the social networking system 140 allows the view state to account for presentation of content items to the user via multiple client devices 110, allowing the user to view a consistent ordering of content items when accessing the news feed via client devices 110.

In one embodiment, the social networking system 140 determines whether to reposition, or to again present a content item previously presented to the user via the news feed. For example, the social networking system 140 may determine whether to reposition an advertisement based on a bid amount associated with the advertisement and received from an advertiser associated with the advertisement. The bid amount specifies an amount of compensation from the advertiser to the social networking system 140 for presenting the advertisement to users of the social networking system 140. In one example, the social networking system 140 receives a request to reposition, or to again present, an advertisement from an advertiser including a bid amount and one or more instructions for repositioning the advertisement. The request from an advertiser includes an identifier associated with an advertisement and a bid amount specifying an amount of compensation from the advertiser to the social networking system 140 for again presenting the advertisement to the user.

Alternatively, the social networking system 140 determines to again present a news feed story to the user based on one or more characteristics of the news feed story. For example, the social networking system 140 determines to reposition a news feed story associated with an additional user to which the user has at least a threshold affinity. Affinity scores of the user for news feed stories previously provided to the user but not viewed by the user or for additional users associated with news feed stories previously provided to the user but not viewed by the user are compared to a threshold value to identify a previously presented news feed story to be again presented to the user or to be repositioned in the news feed.

The social networking system identifies 415 one or more additional content items that were not previously presented to the user via the news feed. For example, new news feed stories are generated by the news feed manager 230 and maintained in a queue for presentation to the user. One or more news feed stories may be identified 415 from this queue as additional content items to include in the updated news feed. Identification of news feed stories is further described in conjunction with U.S. patent application Ser. No. 14/031,453, filed on Sep. 19, 2013, which is hereby incorporated by reference in its entirety. In some embodiments, one or more of the additional content items are identified 415 based on state changes associated with content items that occur after the user viewed the one or more previously provided content items. A state change may indicate, for example, a new content item, a previously presented content item associated with a recent interaction by an additional user of the social networking system 140 connected to the user (e.g., an indication of preference for the previously presented content item, a comment associated with the previously presented content item, sharing the previously presented content item with a user). Additionally, one or more advertisements included in the ad request store 235 and not previously presented to the user may be identified 415 as additional content items. For example, advertisements associated with one or more targeting criteria satisfied by the user and not previously presented to the user are identified 415 from the ad request store 235 as additional content items.

In addition to identifying additional 415 content items not previously presented to the user via the news feed, the social networking system also identifies 420 one or more content items previously presented to the user. For example, news feed stories previously presented to the user but not viewed by the user are identified 420. As another example, the social networking system identifies 420 an advertisement previously presented to the user specified by the received request, such as an advertisement previously presented to the user but with which the user did not interact. To identify 420 one or more content items previously presented to the user, the social networking system 140 determines if the user has viewed content items identified as presented to the user by the view state associated with the user. Content items identified as presented to the user by the view state are identified 420 along with positions in the news feed in which the content items were presented from the view state.

The social networking system 140 scores 425 the additional content items and the identified one or more previously presented content items. A score of a previously presented content item accounts for a value to the social networking system 140 of again presenting the content item in an alternative position in the news feed while accounting for a decrease in value to the social networking system from removing the content item from the position in the news feed in which it was previously presented. Additionally, the score of the previously presented content item may also account for a decrease in value to the social networking system 140 from repositioning content items presented in positions between the alternative position and the position in which the content item was previously presented. If a previously presented content item is an advertisement, its score is determined based on an amount of compensation to the social networking system 140 from presenting the advertisement in an alternative position in the news feed, based on a bid amount associated with the advertisement and an amount of compensation lost to the social networking system 140 for removing the advertisement from the position in which it was originally presented, based on a bid amount previously received for presenting the advertisement.

As described above, position discounts may be associated with different positions in the news feed and discount a bid amount associated with an advertisement based on a position in the news feed in which the advertisement is presented. For example, the value to the social networking system 140 for presenting an advertisement in a position is determined as the bid amount for presenting the advertisement modified by the position discount in which the advertisement is presented. Additionally, the value to the social networking system 140 for presenting the advertisement in a position may account for an expected amount of user interaction with the advertisement, so the value to the social networking system 140 is based on the expected amount of user interaction with the advertisement presented in the position and the bid amount for presenting the advertisement in the position. In one embodiment, the amount of compensation lost to the social networking system 140 for removing an advertisement from the position in which it was originally presented is determined by modifying a previously-received bid amount for presenting the advertisement by a position discount associated with position in the news feed in which the advertisement was originally presented. Further, the score for again presenting an advertisement may also account for an additional cost to the social networking system 140 from displacing content items presented in the news feed in positions between the position and the position in which the advertisement was originally presented. This additional cost represents the value lost by the social networking system 140 from changes in user interaction with the displaced content items in the news feed. The additional cost may be determined based at least in part on a change in expected user interaction with each of the displaced content items presented in positions of the news feed between the alternative position and the position in which the advertisement was originally presented. In one example, the change in expected interaction may be determined by summing the difference between the interaction scores of content items presented in their original positions in the news feed and the interaction scores of the content items presented in a displaced position in the news feed. An example of determining a change in expected interaction with content items based on repositioning is further described in U.S. patent application Ser. No. 14/051,219, filed on Oct. 10, 2013, which is hereby incorporated by reference in its entirety.

Thus, in one embodiment, a value to the social networking system 140 for again presenting a previously presented advertisement, in an alternative position of the news feed is determined by modifying the bid amount for again presenting the advertisement in the alternative position of the feed by the position discount associated with the alternative position of the feed. Note that as used herein, a “previously presented advertisement” (or a “previously presented content item) is an advertisement (or content item) that was eligible to be shown (or otherwise injected into the news feed), but was not viewed by the user. The score of the previously presented advertisement is then determined as the difference between the value to the social networking system 140 for presenting the advertisement in the alternative position less a combination of the compensation lost by the social networking system 140 from presenting the advertisement in its original position, as described above, and the additional cost to the social networking system 140 for displacing content items presented in positions between the alternative position and the position in which the advertisement was originally presented, as described above.

If a previously presented content item is a news feed story, its score is determined based on a value to the social networking system 140 based on an expected amount of interaction with the news feed story presented in an alternative position and a cost to the social networking system 140 in user interaction from lost from removing the news feed story from its original position. An additional cost to the social networking system 140 based on changes in user interaction with displaced content items presented in positions between the alternative position and the position in which the news feed story was originally presented may also be used when scoring 425 a previously presented news feed story. In one embodiment, the score for a previously presented news feed story is a value to the social networking system 140 from an expected amount of user interaction with the news feed story presented in an alternative position in the news feed modified by a position discount associated with the alternative position less an expected amount of user interaction with the news feed story presented in its original position modified by a position discount associated with the original position. An additional cost representing a change in user interaction with displaced content items presented in positions between the alternative position and the original position may also be subtracted from the value to the social networking system. An expected amount of user interaction with a news feed story may be based on an organic value associated with a news feed story; determining an organic value associated with a news feed story is further described in U.S. patent application Ser. No. 12/978,265, filed on Dec. 23, 2010, and U.S. patent application Ser. No. 13/545,266, filed on Jul. 10, 2012, each of which is hereby incorporated by reference in its entirety.

A score of an additional content item, which has not previously been presented to the user, accounts for a value to the social networking system 140 of presenting the content item in a position in the news feed and a cost to the social networking system 140 from displacing content items in positions of the news feed lower than the position in the news feed in which the additional content item is placed. As an example, if an additional content item is an advertisement, its score is determined based on an amount of compensation to the social networking system 140 from a bid amount associated with presenting the advertisement in a position of the news feed and a cost to the social networking system 140 for displacing content items in positions lower than the position in the news feed in which the advertisement is to be presented. The value to the social networking system 140 may account for a position discount associated with a position in the news feed in which the advertisement is to be presented; for example, the value is the bid amount for presenting the advertisement modified by a position discount associated with the position in which the advertisement is to be presented. Similarly, if an additional content item is a news feed story, its value to the social networking system is determined as an expected amount of user interaction with the news feed story modified by a position discount associated with a position in which the news feed story is to be presented.

The cost to the social networking system 140 for presenting an additional content item may be determined based at least in part on a change in expected user interaction with the displaced content items in positions of the feed lower than the position for presenting the additional content item. If the additional content item is an advertisement, its score is a difference between a value to the social networking system 140 for presenting the advertisement, determined by modifying both a bid amount associated with the advertisement and an expected amount of user interaction with the advertisement by a position discount associated with a position in which the advertisement is presented, and a cost to the social networking system 140 for displacing content items in positions lower than the position in which the advertisement is presented, which is based on changes in expected user interaction with the displaced content items. If the additional content item is a news feed story, its score is a difference between an expected amount of user interaction with the news feed story, modified by a position discount associated in a position in which the news feed story is presented, and a cost to the social networking system 140 for displacing content items in positions lower than the position in which the advertisement is presented, which is based on changes in expected user interaction with the displaced content items.

The additional content items and the previously presented content items are then ranked 430 by the social networking system 140 based on their associated scores. In one embodiment, scores associated with additional news feed stories, scores associated with previously presented news feed stories, scores associated with additional advertisements, and scores associated with previously presented advertisements are converted into a common unit of measurement, so advertisements and news feed stories are ranked 430 together in a single ranking. For example, news feed stories and advertisements included in the additional content items and in the previously presented content items are included in a unified ranking. The bid amounts of each of the advertisements are converted into a common unit of measurement as the expected amount of user interaction, allowing the news feed stories and advertisements may be ranked 420 together based on scores represented in the common unit of measurement; alternatively, the expected amount of user interaction with each news feed story or advertisement is converted into an expected value or bid amount, and the news feed stories and advertisements are ranked 430 together based on a score generated from the expected values or bid amount. Ranking both news feed stories and advertisements is further described in U.S. patent application Ser. No. 13/545,266, filed on Jul. 10, 2012, which is hereby incorporated by reference in its entirety. Alternatively, news feed stories are ranked 430 based on their associated scores and advertisements are separately ranked 430 based on their associated scores.

Based on the ranking, one or more content items are selected and provided 435 to a client device 110 for presentation to the user. For example, content items having at least a threshold position in the ranking are selected and provided 435 to the client device 110 for presentation to the user. If a content item previously presented to the user is selected for subsequent presentation, the content item is removed from its original position in the news feed and provided 435 for presentation in an alternative position in the news feed. In one embodiment, content items having at least a threshold position in the ranking are provided in the order determined by the ranking, while remaining content items are presented in a chronological order, such as reverse chronological order. After the new news feed stories are provided 435 to the client device, the view state for the user is updated to include the modified ordering of the content items provided to the user in the news feed to indicate the positions in the news feed in which the content items are presented. The updated view state is stored in the content store 210 and associated with a user profile of the user.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
maintaining a view state for a user of a social networking system, the view state identifying a plurality of content items, including an advertisement, provided to the user in a feed of content items and identifying a position in the feed with each content item provided to the user;
retrieving information from the view state identifying the position in the feed in which the advertisement was previously presented, a bid amount associated with presenting the advertisement in the position, and a position discount associated with the position;
determining a score for presenting the advertisement in an alternative position of the feed based at least in part on a bid amount for presenting the advertisement in the alternative position modified by a position discount associated with the alternative position and the bid amount associated with presenting the advertisement in the position modified by the position discount associated with the position;
identifying one or more additional advertisements for presentation in the feed, each additional advertisement associated with a bid amount and not previously presented in the feed;
determining scores associated with each of the one or more additional advertisements based at least in part on the bid amounts associated with each of the one or more additional advertisements;
selecting one or more advertisements from the one or more additional advertisements and the advertisement based at least in part on the scores associated with each of the one or more additional advertisements and the score for presenting the advertisement in the alternative position of the feed;
presenting the selected the one or more advertisements to the user via the feed.

2. The computer-implemented method of claim 1, wherein presenting the selected the one or more advertisements to the user via the feed comprises:
removing the advertisement from the position and presenting the advertisement in the alternative position if the advertisement was selected.

3. The computer-implemented method of claim 1, wherein determining the score for presenting the advertisement in the alternative position of the feed comprises:
determining a value to the social networking system for presenting the advertisement in the alternative position based at least in part on the bid amount for presenting the advertisement in the alternative position and the position discount associated with the alternative position;
determining a cost to the social networking system for removing the advertisement from the position based at least in part on the bid amount associated with presenting the advertisement in the position and the position discount associated with the position;
determining an additional cost to the social networking system for displacing content items in the feed between the alternative position and the position, the additional cost based at least in part on a change in expected user interaction with each of the displaced content items; and
determining the score for presenting the advertisement in the alternative position of the feed as a difference between the value and a combination of the cost and the additional cost.

4. The computer-implemented method of claim 3, wherein determining scores associated with each of the one or more additional advertisements based at least in part on the bid amounts associated with each of the one or more additional advertisements comprises:
for each of the one or more additional advertisements,
determining a value to the social networking system for presenting an additional advertisement in the feed;
determining a cost to the social networking system for displacing content items in positions of the feed lower than a position for presenting the additional advertisement based at least in part on a change in expected user interaction with the displaced content items in positions of the feed lower than a position for presenting the additional advertisement; and
determining a score for the additional advertisement as a difference between the value to the social networking system for presenting the additional advertisement and the cost to the social networking system for displacing the content items in positions of the feed lower than the position for presenting the additional advertisement.

5. The computer-implemented method of claim 4, wherein determining the value to the social networking system for presenting the additional advertisement in the feed comprises:
determining a value to the social networking system for presenting the additional advertisement in a position in the feed based at least in part on the bid amount for presenting the additional advertisement and a position discount associated with the position for presenting the additional advertisement;

6. The computer-implemented method of claim 1, wherein selecting one or more advertisements from the one or more additional advertisements and the advertisement based at least in part on the scores associated with each of the one or more additional advertisements and the score for presenting the advertisement in the alternative position of the feed comprises:
ranking the additional advertisements and the advertisement based at least in part on the scores associated with each of the one or more additional advertisements and the score for presenting the advertisement in the alternative position of the feed; and
selecting the one or more advertisements based at least in part on the ranking.

7. The computer-implemented method of claim 1, further comprising:
updating the view state for the user to identify the selected one or more advertisements and an order in which the selected one or more content items were presented in the feed.

8. The computer-implemented method of claim 1, wherein the advertisement that was previously presented comprises an advertisement that was selected to be presented in the news feed but was not viewed by the user.

9. A computer-implemented method comprising:
receiving a plurality of advertisements for presentation to a user of a social networking system via a feed of content items, at least one of the advertisements presented in a position of the feed;
determining a score for each advertisement, the determining comprising:
for an advertisement not currently presented via the feed, determining a value of presenting the advertisement not currently presented via the feed less a cost of displacing content items presented via the feed in positions below a position for presenting the advertisement not currently presented via the feed;
for an advertisement presented in the position of the feed, determining a value of presenting the advertisement in an alternative position of the feed above the position of the feed less a cost of displacing content items presented via the feed in positions between the alternative position and the position and less an additional cost of removing the advertisement from the position of the feed;
selecting one or more advertisements from the plurality of advertisements based at least in part on the scores; and
presenting the selected one or more advertisements via the feed, the presenting comprising removing the advertisement from the position if the advertisement was previously presented via the feed.

10. The computer-implemented method of claim 9, wherein the value of presenting the advertisement not currently presented via the feed is based at least in part on a bid amount associated with the advertisement not currently presented via the feed and a position discount associated with the position for presenting the advertisement not currently presented via the feed.

11. The computer-implemented method of claim 9, wherein the cost of displacing content items presented via the feed in positions below the position for presenting the advertisement not currently presented via the feed is based at least in part on a change in expected interaction with each of the displaced content items caused by the displacement.

12. The computer-implemented method of claim 9, wherein the value of presenting the advertisement in the alternative position of the feed above the position of the feed is based at least in part on a bid amount associated with presenting the advertisement in the alternative position and a position discount associated with the alternative position.

13. The computer-implemented method of claim 9, wherein the cost of displacing content items presented via the feed in positions between the alternative position and the position is based at least in part on a change in expected interaction with each of the displaced content items caused by the displacement.

14. The computer-implemented method of claim 9, wherein the additional cost of removing the advertisement from the position of the feed is based at least in part on a bid amount associated with presenting the advertisement in the position and a position discount associated with the position.

15. A computer-implemented method comprising:
receiving a plurality of content items for presentation to a user of a social networking system via a feed of content items, at least one of the content items presented in a position of the feed;
determining a score for each content item, the determining comprising:
for a content item not currently presented via the feed, determining a value of presenting the content item via the feed less a cost of displacing content items presented via the feed in positions below a position for presenting the content item not currently presented via the feed;
for a content item presented in the position of the feed, determining a value of presenting the content item in an alternative position of the feed above the position of the feed less a cost of displacing content items presented via the feed in positions between the alternative position and the position and less an additional cost of removing the content item from the position of the feed;
selecting one or more content items from the plurality of content items based at least in part on the scores; and
presenting the selected one or more content items via the feed, the presenting comprising removing the content item from the position if the content item was previously presented via the feed.

16. The computer-implemented method of claim 15, wherein the cost of displacing content items presented via the news feed in positions below the position for presenting the content item not currently presented via the feed is based at least in part on a change in expected interaction with each of the displaced content items caused by the displacement.

17. The computer-implemented method of claim 15, wherein the cost of displacing content items presented via the feed in positions between the alternative position and the position is based at least in part on a change in expected interaction with each of the displaced content items caused by the displacement.

18. The computer-implemented method of claim 15, wherein the additional cost of removing the content item from the position of the feed is based at least in part on an expected amount of user interaction with the content item presented in the position and a position discount associated with the position.

19. The computer-implemented method of claim 15, wherein the value of presenting the content item in the alternative position of the feed above based at least in part on an expected amount of user interaction with the content item when presented in the alternative position and a position discount associated with the alternative position.

20. The computer-implemented method of claim 15, wherein the value of presenting the content item via the feed is based at least in part on an expected amount of user interaction with the content item and a position discount associated with the position for presenting the advertisement not currently presented via the feed.

21. The computer-implemented method of claim 15, wherein the plurality of content items include one or more news feed stories describing actions of additional users of the social networking system connected to the user.
